(19) United States
(12) Patent Application Publication
(10) Pub. No.: US 2025/0062386 A1
(43) Pub. Date: Feb. 20, 2025

(54) SECONDARY BATTERY

(71) Applicant: Samsung SDI Co., Ltd., Yongin-si (KR)

(72) Inventors: Min Seung KANG, Yongin-si (KR); Eun Song LEE, Yongin-si (KR); Eon Woo PARK, Yongin-si (KR); Kyung Ho KIM, Yongin-si (KR); Kyeong Yun PARK, Yongin-si (KR); Myeong Jun JO, Yongin-si (KR)

(21) Appl. No.: 18/668,005

(22) Filed: May 17, 2024

(30) Foreign Application Priority Data
Aug. 17, 2023 (KR) 10-2023-0107580

(51) Int. Cl. H01M 10/04; H01M 50/46; H01M 50/531

(52) U.S. Cl. CPC H01M 10/0431; H01M 50/46; H01M 50/531

(57) ABSTRACT

A secondary battery includes an electrode assembly including a first separator, a negative electrode plate on the first separator, a second separator on the negative electrode plate, and a positive electrode plate on the second separator, the electrode assembly wound in a jelly-roll shape having a winding start end and a winding finish end, and having a flat portion, and curved portions respectively at one side of the flat portion and at another side of the flat portion, and a finishing tape attached to the winding finish end of the electrode assembly wound in the jelly-roll shape, wherein the positive electrode plate covers an outer surface of the electrode assembly wound in the jelly-roll shape, and has a finish end terminating on the flat portion.

### CROSS-REFERENCE TO RELATED APPLICATIONS

The present application claims priority to and the benefit of Korean Patent Application No. 10-2023-0107580, filed on Aug. 17, 2023, in the Korean Intellectual Property Office, the entire disclosure of which is incorporated herein by reference.

### BACKGROUND

### 1. Field

Embodiments relate to a secondary battery.

### 2. Description of the Related Art

A secondary battery is a chargeable and dischargeable battery, unlike a primary battery, which is not chargeable. Low-capacity secondary batteries may be used in portable small electronic devices, such as smart phones, feature phones, notebook computers, digital cameras, and camcorders, and large-capacity secondary batteries may be widely used for a power source and power storage for driving a motor, such as hybrid vehicles, electric vehicles, and the like.

Such a secondary battery may include an electrode assembly including a positive electrode and a negative electrode, a case accommodating the electrode assembly, and an electrode terminal connected to the electrode assembly. The case may be classified into circular-, prismatic-, and pouch-type according to the shape thereof. Among them, the pouch-type secondary battery may be provided as a laminate exterior that may be suitably deformed into various shapes, and that may have a low weight.

Referring to FIG. 1A, a pouch-type secondary battery 10 includes an electrode assembly 11 including a positive electrode plate 21 and a negative electrode plate 23, a negative electrode tab 11a and a positive electrode tab 11b, which extend from the electrode assembly, and an exterior (e.g., a laminate exterior) 13 accommodating the electrode assembly 11. Referring to FIG. 1B, the electrode assembly 11 includes a jelly roll 20 in which the positive electrode plate 21, a separator 22, and a negative electrode plate 23 are sequentially stacked and wound in a longitudinal direction, and includes a finishing tape 30 attached to a winding end of the jelly roll 20. In one or more embodiments, the separator 22 of the jelly roll 20 of the electrode assembly 11 may be exposed to the outside of the positive electrode plate 21 and the negative electrode plate 23 in the wound state. The separator 22 may be attached to be fixed by the finishing tape 30.

Returning to FIG. 1A, the laminate exterior 13 may accommodate the electrode assembly 11, and may be formed by sealing an outer circumference of the electrode assembly 11. The laminate exterior 13 may have a recess 14 having a corresponding depth to substantially accommodate the electrode assembly 11. A negative electrode tab 11a and a positive electrode tab 11b of the electrode assembly 11 may be withdrawn out of the laminate exterior 13. An insulating member may be formed on each of the negative electrode tab 11a and the positive electrode tab 11b, and may be sealed together with a sealing part 13a. In one or more embodiments, the insulating member may be formed at a portion at which the negative electrode tab 11a and the positive electrode tab 11b contact the sealing part 13a, and the likelihood of the negative electrode tab 11a and the positive electrode tab 11b being electrically short-circuited with the laminate exterior 13 may be reduced or prevented.

As described above, after the electrode assembly 11 is sealed and accommodated inside the laminate exterior 13, and the assembly of the secondary battery is completed, a formation process may be performed to give electrical characteristics to an assembled cell through the charging and discharging. However, the electrode assembly repeats contraction and expansion as the formation charging and discharging are repeated, and, for example, large tension due to the cell expansion may act relatively intensively on a curved portion at each of both ends of the jelly roll. Thus, there may occur a limitation in which the positive electrode plate 21 located at the outermost side of the jelly roll 20 of the electrode assembly 11 may not withstand the tension, and may be broken after reaching a stretching limit.

### SUMMARY

Aspects of one or more embodiments of the present disclosure provide a secondary battery provided with an electrode assembly having a structure capable of avoiding rupture of the outermost positive electrode plate of the electrode assembly due to formation charging and discharging.

According to one or more embodiments, a secondary battery includes an electrode assembly including a first separator, a negative electrode plate on the first separator, a second separator on the negative electrode plate, and a positive electrode plate on the second separator, the electrode assembly wound in a jelly-roll shape having a winding start end and a winding finish end, and having a flat portion, and curved portions respectively at one side of the flat portion and at another side of the flat portion, and a finishing tape attached to the winding finish end of the electrode assembly wound in the jelly-roll shape, wherein the positive electrode plate covers an outer surface of the electrode assembly wound in the jelly-roll shape, and has a finish end terminating on the flat portion.

The finish end of the positive electrode plate, a finish end of the negative electrode plate, a finish end of the first separator, and a finish end of the second separator may be on the flat portion.

The positive electrode plate may cover an entirety of outermost sides of the negative electrode plate, the first separator, and the second separator.

The finish end of the first separator and the finish end of the second separator may extend in a winding direction further than the finish end of the negative electrode plate, and the finish end of the positive electrode plate may extend further in the winding direction than the finish end of the first separator and the finish end of the second separator.

The positive electrode plate may sequentially and repeatedly wrap the curved portion at the one side of the flat portion and the curved portion at the other side of the flat portion, the positive electrode plate covering and extending beyond a central portion of the flat portion such that the finish end of the positive electrode plate is between one of the curved portions and the central portion.

Negative electrode tabs may be respectively at a start end of the negative electrode plate and the finish end of the negative electrode plate, positive electrode tabs may be respectively at a start end of the positive electrode plate and the finish end of the positive electrode plate, and the finish end of the positive electrode plate may extend in a winding direction further than the finish end of the negative electrode plate by about 30 mm or more.

The start end and the finish end of the positive electrode plate may overlap in a thickness direction of the electrode assembly, the start end and the finish end of the negative electrode plate may overlap the thickness direction of the electrode assembly.

### BRIEF DESCRIPTION OF THE DRAWINGS

The accompanying drawings are included to provide a further understanding of the present disclosure, and are incorporated in and constitute a part of this specification. The drawings illustrate embodiments of the present disclosure and, together with the description, serve to explain aspects of the present disclosure. In the drawings:

FIG. 1A illustrates an exploded perspective view of a pouch-type secondary battery;

FIG. 1B illustrates a perspective view of an electrode assembly;

FIG. 1C illustrates a cross-sectional view of a state after the electrode assembly is wound;

FIG. 2 illustrates a perspective view of an electrode assembly of a secondary battery according to one or more embodiments;

FIG. 3 illustrates a plan view if viewed from front and rear sides of the electrode assembly of FIG. 2;

FIG. 4 illustrates a cross-sectional view of a state after the electrode assembly of FIG. 2 is wound; and

FIGS. 5A and 5B illustrate a view of a state before the electrode assembly of FIG. 4 is wound.

### DETAILED DESCRIPTION

Aspects of one or more embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure. The present disclosure covers all modifications, equivalents, and replacements within the idea and technical scope of the present disclosure. Further, each of the features of the various embodiments of the present disclosure may be combined with each other, in part or in whole, and technically various interlocking and driving are possible. Each embodiment may be implemented independently of each other or may be implemented together in an association.

In the drawings, the relative sizes of elements, layers, and regions may be exaggerated for clarity and/or descriptive purposes. Additionally, the use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified.

Various embodiments are described herein with reference to sectional illustrations that are schematic illustrations of embodiments and/or intermediate structures. As such, variations from the shapes of the illustrations as a result of, for example, manufacturing techniques and/or tolerances, are to be expected. Further, specific structural or functional descriptions disclosed herein are merely illustrative for the purpose of describing embodiments according to the concept of the present disclosure. Thus, embodiments disclosed herein should not be construed as limited to the illustrated shapes of elements, layers, or regions, but are to include deviations in shapes that result from, for instance, manufacturing.

Spatially relative terms, such as “beneath,” “below,” “lower,” “lower side,” “under,” “above,” “upper,” “upper side,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below,” “beneath,” “or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. Similarly, when a first part is described as being arranged “on” a second part, this indicates that the first part is arranged at an upper side or a lower side of the second part without the limitation to the upper side thereof on the basis of the gravity direction.

Further, the phrase “in a plan view” means when an object portion is viewed from above, and the phrase “in a schematic cross-sectional view” means when a schematic cross-section taken by vertically cutting an object portion is viewed from the side. The terms “overlap” or “overlapped” mean that a first object may be above or below or to a side of a second object, and vice versa. Additionally, the term “overlap” may include stack, face or facing, extending over, covering, or partly covering or any other suitable term as would be appreciated and understood by those of ordinary skill in the art. The expression “not overlap” may include meaning, such as “apart from” or “set aside from” or “offset from” and any other suitable equivalents as would be appreciated and understood by those of ordinary skill in the art. The terms “face” and “facing” may mean that a first object may directly or indirectly oppose a second object. In a case in which a third object intervenes between a first and second object, the first and second objects may be understood as being indirectly opposed to one another, although still facing each other.

It will be understood that when an element, layer, region, or component is referred to as being “formed on,” “on,” “connected to,” or “(operatively or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection. For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a resistor, a capacitor, and/or the like. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

In addition, in the present specification, when a portion of a layer, a film, an area, a plate, or the like is formed on another portion, a forming direction is not limited to an upper direction but includes forming the portion on a side surface or in a lower direction. On the contrary, when a portion of a layer, a film, an area, a plate, or the like is formed “under” another portion, this includes not only a case where the portion is “directly beneath” another portion but also a case where there is further another portion between the portion and another portion. Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XYY, YZ, and ZZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are used only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

As used herein, the term “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5% of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.”

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

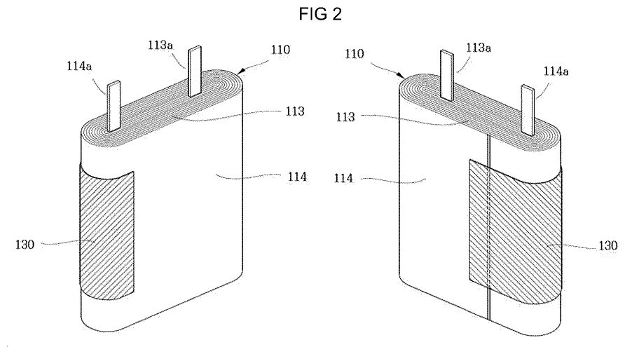

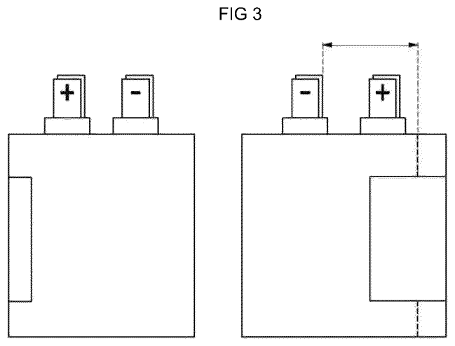

FIG. 2 illustrates a perspective view of an electrode assembly of a secondary battery according to one or more embodiments, and FIG. 3 illustrates a plan view if viewed from front and rear sides of the electrode assembly of FIG. 2. An electrode assembly 110 according to one or more embodiments may be provided by sequentially winding a positive electrode plate 114, a pair of separators 111 and 112, and a negative electrode plate 113.

The positive electrode plate 114 and the negative electrode plate 113 may be slightly different depending on the type of secondary batteries, but are generally provided by applying and filling an active material to a metal base material, and then by performing drying, roll pressing, and cutting of the resultant metal base material. In a lithium ion secondary battery, the positive electrode plate 114 may use lithium transition metal oxide as the active material, and may use aluminum as a current collector. In one or more embodiments, the negative electrode plate 113 may use carbon and a carbon composite as the active material, and may use a current collector made of copper. In one or more embodiments, the separators 111 and 112 may use a microporous membrane made of a polyolefin-based resin, such as polyethylene or polypropylene, to separate the positive electrode plate 114 and the negative electrode plate 113 from each other, so that the positive electrode plate 114 and the negative electrode plate 113 are not in direct contact with each other and are not short-circuited.

After the positive electrode plate 114, the negative electrode plate 113, and the separators 111 and 112, which are configured in this manner, are wound in a stacked state, a finishing tape 130 may attach a winding end of the electrode assembly 110 to an outer circumferential surface of the electrode assembly 110 to fix the wound state of the positive electrode plate 114, the separators 111 and 112, and the negative electrode plate 113.

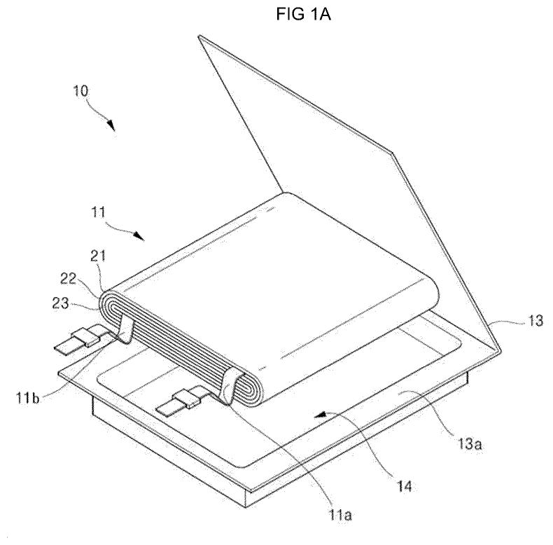

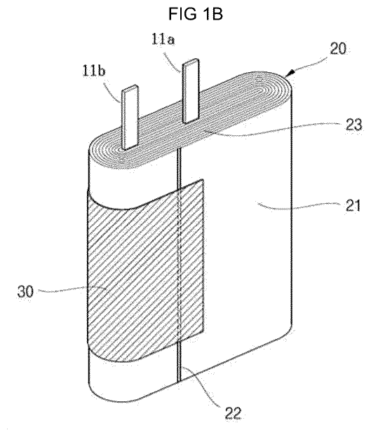

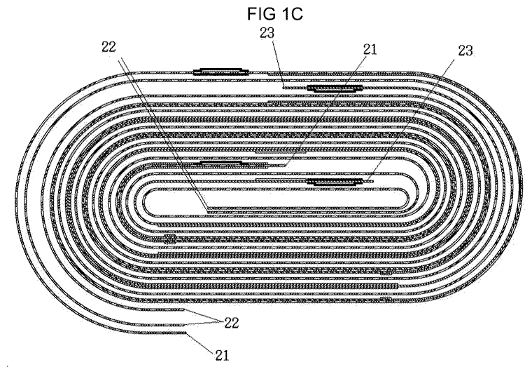

Referring to FIGS. 1B and 1C, an electrode assembly 110 having a general structure may be the jelly roll-type electrode assembly provided in an oval shape having a flat portion, and curved portions at respective ends of the flat portion. The electrode assembly 110 may be designed so that, after winding of the negative electrode plate 23 is completed, the positive electrode plate 21 and the pair of separators 22 are wound longer in the winding direction beyond an end of the negative electrode plate 23. After at least one curved portion (e.g., the left curved portion in FIG. 1C) of the electrode assembly is curved, the winding may be finished at the flat portion between the curved portions. In one or more embodiments, an end of the positive electrode plate 21 and the ends of the pair of separators 22 may be winding ends of the electrode assembly, and may be attached and fixed to the outermost side of the electrode assembly by the finishing tape.

Unlike this structure, the electrode assembly 110 according to one or more embodiments may be configured so that ends of the positive electrode plate 114 are further wound while wrapping ends of the separators 111 and 112 and the negative electrode plate 113, and winding of an end of the positive electrode plate 114 may terminate on a flat portion.

Hereinafter, a structure of the electrode assembly 110 according to one or more embodiments, in which the positive electrode plate 114 covers the outermost circumferential surface of the electrode assembly 110, and in which the end of the at least the positive electrode plate 114 is wound on the flat portion, will be described in detail.

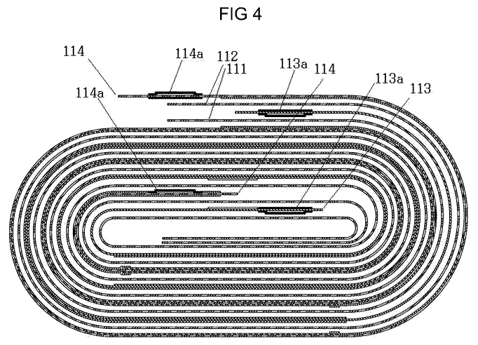

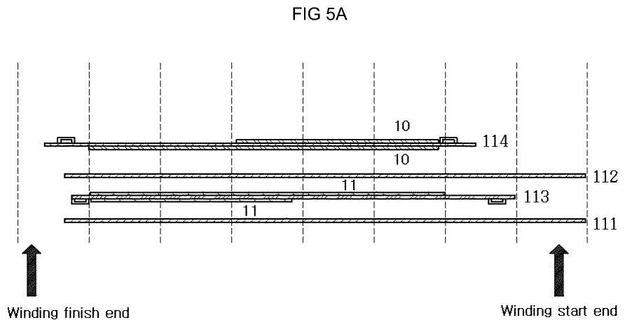

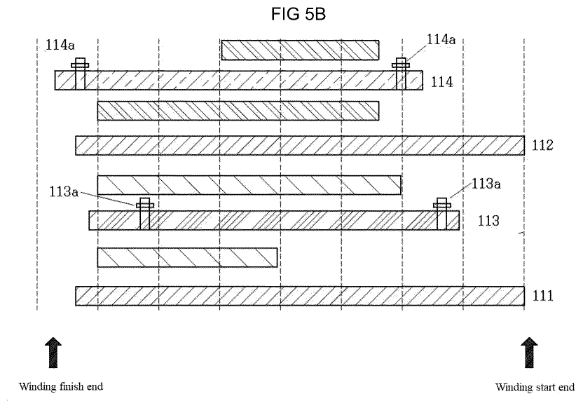

FIG. 4 illustrates a cross-sectional view of a state after the electrode assembly of FIG. 2 is wound, and FIGS. 5A and 5B illustrate a view of a state before the electrode assembly of FIG. 4 is wound. The electrode assembly 110 according to one or more embodiments may include a first separator 111, a negative electrode plate 113 located on the first separator 111, a second separator 112 located on the negative electrode plate 113, and a positive electrode plate 114 located on the second separator 112. In one or more embodiments, the first separator 111, the negative electrode plate 113, the second separator 112, and the positive electrode plate 114 may be stacked and then wound in the form of a jelly roll having a winding start end and a winding finish end. In one or more embodiments, the finishing tape 130 may be attached to the winding finish end of the electrode assembly 110.

For reference, the electrode assembly 110 illustrated in FIG. 4 may be in a state after the winding, and the electrode assembly 110 illustrated in FIGS. 5A and 5B may be in the stacked state before the winding. In one or more embodiments, although an outer appearance in two different cases may be slightly different, the electrode assembly 110 that is in a state of being able to be accommodated in an exterior (e.g., laminate exterior), may be substantially illustrated in FIG. 4. A mutual relationship between the negative electrode plate 113, the separators 111 and 112, and the positive electrode plate 114 may be more accurately illustrated in the form illustrated in FIG. 4. In one or more embodiments, in reality, the negative electrode plate 113, the separators 111 and 112, and the positive electrode plate 114 may be in close contact with each other, but for easy understanding of embodiments, the components may be illustrated as being spaced apart from each other in FIGS. 5A and 5B.

Referring to FIGS. 5A and 5B, a plurality of dotted lines illustrated in a vertical direction may respectively correspond to an area, a winding area, or winding turn number in which the electrode assembly 110 is folded during the winding process of the electrode assembly 110. In one or more embodiments, a width of the respective folded areas may gradually widen as winding are overlapped. However, for ease of explanation of embodiments, the folded areas are depicted by using the dotted lines in FIGS. 5A and 5B, and thus FIGS. 5A and 5B may not exactly match the electrode assembly 110 illustrated in FIG. 4. In one or more embodiments, in FIGS. 5A and 5B, it is assumed that a right end is the winding start end, a left end is the winding finish end, and the winding direction is a clockwise direction. The winding start end may refer to an area at which the winding begins during the winding process of the electrode assembly 110 (e.g., an area held by a core clamp), and the winding finish end may refer to an area at which the winding is finished during the winding process of the electrode assembly 110. The above aspects and assumptions may be shared by all embodiments of the present disclosure.

In one or more embodiments, the negative electrode tab 113a and the positive electrode tab 114a at the winding start end may be generally located at an inner circumference (or inner center) of the wound electrode assembly 110. The negative electrode tab 113a and the positive electrode tab 114a at the winding finish end may be located generally at an outer circumference (or outer surface or inner surface) of the wound electrode assembly 110. In one or more embodiments, the winding finish end may be generally located at the outermost side of the electrode assembly 110. The electrode assembly 110 described below may be only an example for understanding embodiments. It may be understood that, with respect to formation positions of the tab, an active material layer (e.g., active material coating portion), and/or a non-coating portion (active material non-coating portion) may be variously changed depending on characteristics of the secondary battery.

The negative electrode plate 113 may include a negative electrode active material layer 11 applied on one or both sides of a negative electrode current collector plate made of a conductive metal thin plate (e.g., copper or nickel foil or mesh). For example, the negative electrode active material layer 11 may be made of a carbon-based material, Si, Sn, tin oxide, a tin alloy composite, transition metal oxide, lithium metal nitrite, or metal oxide. For example, the substantially flat negative electrode tab 113a may be fixed (e.g., welded) to the negative electrode non-coating portion, upon which the negative electrode active material layer 11 is not applied on the negative electrode current collector plate. In one or more embodiments, one end of the negative electrode plate 113 may be electrically connected to the negative electrode non-coating portion, and the other end may protrude and extend outwardly. In one or more embodiments, an insulating member may be attached to the negative electrode tab 113a to reduce or prevent the likelihood of the negative electrode tab 113a from being short-circuited with the laminate exterior.

The positive electrode plate 114 may include a positive electrode active material layer 10 applied on one or both sides of a positive electrode current collector plate made of, for example, a thin metal plate with excellent conductivity (e.g., aluminum foil or mesh). In one or more embodiments, the positive electrode active material layer 10 may include, for example, a chalcogenide compound, such as a composite metal oxide (e.g., LiCoO₂, LiMn₂O₄, LiNiO₂, LiNiMnO₂, or the like). For example, the positive electrode tabs 114a and 115 may be fixed (e.g., welded) to the positive electrode non-coating portion on which the positive electrode active material layer 10 is not applied on the positive electrode current collector plate. In one or more embodiments, an insulating member may be attached to the positive electrode tab 114a to reduce or prevent the likelihood of the positive electrode tab 114a from being short-circuited with the laminate exterior.

The separators 111 and 112 may be interposed between the negative electrode plate 113 and the positive electrode plate 114 to reduce or prevent the likelihood of an electrical short circuit therebetween. In reality, the pair of separators may be provided, and the negative electrode plate 113 may be sandwiched between the pair of separators (the first separator 111 and the second separator 112). In one or more embodiments, the separator may be made of, for example, any one selected from the group including polyethylene, polypropylene, or a porous copolymer of polyethylene and/or polypropylene. The separator may be wider than the electrode plate so as to reduce or prevent the likelihood of an electrical short circuit between the negative electrode plate 113 and the positive electrode plate 114.

The electrode assembly 110 provided in this manner may be provided by sequentially winding the separator 111, the negative electrode plate 113, the separator 112, and the positive electrode plate 114. Referring to FIG. 4, in the jelly roll-type electrode assembly 110 according to one or more embodiments, the winding finish end of the positive electrode plate 114 may extend to be longer than the winding finish ends of the first and second separators 111 and 112 and the negative electrode plate 113 in a longitudinal direction, and the outermost circumferential surface of the electrode assembly 110 may be covered with the positive electrode plate 114 after the winding.

To explain the above winding shape, the stacked structure of the electrode assembly 110 in FIGS. 5A and 5B will be described.

First, the pair of separators (first and second separators 111 and 112) may protrude to contact each other at the winding start end, and the first and second separators 111 and 112 may be fixed to the core clamp in a state of contacting each other at the winding start end. Thereafter, the electrode assembly 110 may rotate around the core clamp, and may be continuously wound from the winding start end to the winding finish end.

The negative electrode plate 113 may be interposed between the pair of separators 111 and 112. The start end of the negative electrode plate 113 may be located behind (e.g., may begin after) the first and second separators 111 and 112 in the winding direction, and a finish end of the negative electrode plate 113 may be located behind (e.g., may terminate before) the first and second separators 111 and 112 in the winding direction. In one or more embodiments, the negative electrode plate 113 may be wound and rolled together with the separator while being interposed between the first and second separators 111 and 112, and the winding of the negative electrode plate 113 may complete before the first and second separators 111 and 112. In one or more embodiments, and referring to FIG. 4, the winding of the negative electrode plate 113 may finish at the flat portion of the jelly roll-type electrode assembly 110. In one or more embodiments, after the winding of the negative electrode plate 113 is finished, the two separators 111 and 112 may be wound to extend beyond the winding finish of the negative electrode plate 113. The winding may be finished at the flat portion before reaching a curved portion.

The wound start end of the positive electrode plate 114 may be located on an upper portion of the second separator 112. The start end of the positive electrode plate 114 may be located behind the first and second separators 111 and 112 in the winding direction, and a finish end of the positive electrode plate 114 may extend further than (e.g., may terminate after) the finish ends of the first and second separators 111 and 112.

As described above, the positive electrode plate 114 may be wound to be rolled together with the first separator 111, the negative electrode plate 113, and the second separator 112. All of the finish ends of the positive electrode plate 114, the negative electrode plate 113, and the first and second separators 111 and 112 may be located on the same flat portion. The winding of the negative electrode plate 113 may terminate first on the same flat portion, and then, the winding of the two separators 111 and 112 may be finished. Then, the positive electrode plate 114 may be further wound in the winding direction after the negative electrode plate 113 and the separators 111 and 112 are wound, and the winding of the positive electrode plate 114 may finish before reaching the curved portion.

Referring to FIG. 4, in describing the structure of the winding finish end in more detail, the two separators 111 and 112, the negative electrode plate 113, and the positive electrode plate 114 may reach the flat portion after being curved while wrapping around the right curved portion of FIG. 4. The winding of the finish end of the negative electrode plate 113 may terminate at the flat portion, the winding of the first and second separators 111 and 112 may terminate while extending from the corresponding flat portion toward the left curved portion of FIG. 4, and the winding of the positive electrode plate 114 may terminate while extending further from the corresponding flat portion toward the left curved portion of FIG. 4.

In one or more embodiments, the finish end of the negative electrode plate 113 may be wrapped by the two separators, and may not be exposed to the outside (e.g., may be covered). The finish ends of the two separators may be covered by the positive electrode plate 114, and may not be exposed to the outside. As a result, if the winding process is completed, only the finish end of the positive electrode plate 114 may be exposed at the outermost side of the electrode assembly 110.

In more details, referring to FIG. 4, the winding of all of the finish ends of the negative electrode plate 113, the first and second separators 111 and 112, and the positive electrode plate 114 may be finished at the flat portion of the electrode assembly 110. The winding finish positions may be different in one or more embodiments, and the winding of the negative electrode plate 113 may finish at an arbitrary position on the flat portion. The winding of the finish ends of the first and second separators 111 and 112 may be finished at a position that extends further in the winding direction than the finish end of the negative electrode plate 113. Referring to FIG. 5A, this may result from the first and second separators 111 and 112 extending longer in the longitudinal direction than the negative electrode plate 113 at the winding finish end side. In one or more embodiments, the winding of the finish end of the positive electrode plate 114 may terminate at a position extending further in the winding direction than the end of the first and second separators 111 and 112. Referring to FIG. 5A, this may be a result of the positive electrode plate 114 at the winding finish end side extending further in the longitudinal direction than the first and second separators 111 and 112.

In one or more embodiments, the positive electrode plate 114 may be wound to sequentially and repeatedly wrap the curved portion at one side, and the curved portion at the other side. Then, the winding may be finished after wrapping any one of the two curved portions. The winding of the finish end of the positive electrode plate 114 may be at a position closer to the other curved portion, with respect to a central portion between the two curved portions.

In one or more embodiments, in the winding process, the finish end of the positive electrode plate 114 may be located on the flat portion of the electrode assembly 110 after covering an entirety of the outermost sides of the electrode assembly 110 one or more times.

Referring to FIG. 4, in one or more embodiments, in the state in which the winding of the electrode assembly 110 is completed, the start and finish ends of the positive electrode plate 114 may overlap each other in a thickness direction of the jelly roll, and the start and finish ends of the negative electrode plate 113 may overlap each other in the thickness direction of the jelly roll.

In one or more embodiments, the negative electrode tab 113a may be provided on each of the start and finish ends of the negative electrode plate 113. The positive electrode tabs 114a may be provided at each of the start and finish ends of the positive electrode plate 114. The winding of the finish end of the positive electrode plate 114 may be finished to extend by, for example, about 30 mm further in the winding direction than the negative electrode tab 113a provided on the finish end of the negative electrode plate 113.

The finishing tape 130 may attach the wound end of the electrode assembly 110 to the outer circumferential surface of the electrode assembly 110 to fix the wound state of the positive electrode plate 114, the separators 111 and 112, and the negative electrode plate 113.

Referring to FIG. 1C, in the electrode assembly, the positive electrode plate 21 and the separator 22 of the electrode assembly may be located at the outermost side after the winding is completed. The winding of the positive electrode plate 21 and the separator 22 may be finished after being curved at the left curved portion of FIG. 1C. In one or more embodiments, the winding of the positive electrode plate 21 and the separator 22 may be finished after extending to substantially the same position on the flat portion. The finish end of the separator 22 may be exposed to the outside.

In one or more embodiments, if the winding of the positive electrode plate 21 and the separator 22 are finished at the position immediately after the last curved portion is wrapped and then curved, the positive electrode plate 21 may be affected by tension concentrated to the curved portion during the formation charging and discharging process, which may cause a limitation in which the positive electrode plate 21 is ruptured after reaching a stretching limit. In one or more embodiments, if the finish end of the separator 22 is exposed to the outside after the winding is finished, there may be a limitation that deformation occurs due to heat shrinkage.

In one or more embodiments, in the electrode assembly 110, because the winding of the positive electrode plate 114 is finished to extend beyond the finish end of the separator, the likelihood of exposure of the finished end of the separator to the outside may be reduced or prevented. In one or more embodiments, because the winding of the positive electrode plate 114 is finished to extend until reaching the next curved portion after being curved while wrapping the curved portion, the negative effect of the expansion and contraction due to the tension acting on the previous curved portion may be avoided. In one or more embodiments, the rupture of the positive electrode plate 114 may be avoided.

According to the embodiments, because the positive electrode plate is curved while wrapping the curved portion and extends to reach the curved portion so that the winding is finished, the aspect of the contraction and the expansion due to the tension acting on the curved portion may be avoided.

The above-mentioned embodiments are merely examples of the secondary battery, and the present disclosure is not limited to the foregoing, and also it will be understood by those of ordinary skill in the art that various changes in form and details may be made therein without departing from the spirit and scope of the present disclosure as defined by the following claims, with functional equivalents thereof to be included therein.

What is claimed is:

1. A secondary battery comprising:
an electrode assembly comprising a first separator, a negative electrode plate on the first separator, a second separator on the negative electrode plate, and a positive electrode plate on the second separator, the electrode assembly wound in a jelly-roll shape having a winding start end and a winding finish end, and having a flat portion, and curved portions respectively at one side of the flat portion and at another side of the flat portion; and
a finishing tape attached to the winding finish end of the electrode assembly wound in the jelly-roll shape,
wherein the positive electrode plate covers an outer surface of the electrode assembly wound in the jelly-roll shape, and has a finish end terminating on the flat portion.

2. The secondary battery as claimed in claim 1, wherein the finish end of the positive electrode plate, a finish end of the negative electrode plate, a finish end of the first separator, and a finish end of the second separator are on the flat portion.

3. The secondary battery as claimed in claim 1, wherein the positive electrode plate covers an entirety of outermost sides of the negative electrode plate, the first separator, and the second separator.

4. The secondary battery as claimed in claim 3, wherein the finish end of the positive electrode plate, a finish end of the negative electrode plate, a finish end of the first separator, and a finish end of the second separator are on the flat portion.

5. The secondary battery as claimed in claim 4, wherein the finish end of the first separator and the finish end of the second separator extend in a winding direction further than the finish end of the negative electrode plate, and
wherein the finish end of the positive electrode plate extends further in the winding direction than the finish end of the first separator and the finish end of the second separator.

6. The secondary battery as claimed in claim 5, wherein the positive electrode plate sequentially and repeatedly wraps the curved portion at the one side of the flat portion and the curved portion at the other side of the flat portion, the positive electrode plate covering and extending beyond a central portion of the flat portion such that the finish end of the positive electrode plate is between one of the curved portions and the central portion.

7. The secondary battery as claimed in claim 4, wherein negative electrode tabs are respectively at a start end of the negative electrode plate and the finish end of the negative electrode plate,
wherein positive electrode tabs are respectively at a start end of the positive electrode plate and the finish end of the positive electrode plate, and
wherein the finish end of the positive electrode plate extends in a winding direction further than the finish end of the negative electrode plate by about 30 mm or more.

8. The secondary battery as claimed in claim 4, wherein the start end and the finish end of the positive electrode plate overlap in a thickness direction of the electrode assembly, and
wherein the start end and the finish end of the negative electrode plate overlap the thickness direction of the electrode assembly.
